(19) United States
(12) Patent Application Publication
(10) Pub. No.: US 2023/0079689 A1
(43) Pub. Date: Mar. 16, 2023

(54) Internet Protocol Security (IPsec) Simplification in Border Gateway Protocol (BGP)-Controlled Software-Defined Wide Area Networks (SD-WANs)

(71) Applicant: Huawei Technologies Co., Ltd., Shenzhen (CN)

(72) Inventor: Linda Dunbar, Plano, TX (US)

(21) Appl. No.: 17/987,598

(22) Filed: Nov. 15, 2022

Related U.S. Application Data
(63) Continuation of application No. PCT/US2021/032196, filed on May 13, 2021.
(60) Provisional application No. 63/025,741, filed on May 15, 2020.

(51) Int. Cl. H04L 9/40; H04L 45/42

(52) U.S. Cl. CPC H04L 63/029; H04L 63/061; H04L 45/42

(57) ABSTRACT

A method implemented by a first edge node in an SD-WAN, the method comprises: establishing a secure management tunnel between an RR in the SD-WAN and the first edge node; advertising properties of the first edge node to the RR via the secure management tunnel for the RR to propagate the properties to a second edge node; establishing a first secure data channel with the second edge node; and exchanging first information with the second edge node. A method implemented by an RR in an SD-WAN, the method comprises: receiving first RTC NLRI from a first edge node in the SD-WAN; receiving second RTC NLRI from a second edge node in the SD-WAN; installing an outbound route filter based on the first RTC NLRI; and processing the second RTC NLRI based on the outbound route filter.

### CROSS-REFERENCE TO RELATED APPLICATIONS

This is a continuation of Int'l Patent App. No. PCT/US2021/032196 filed on May 13, 2021, which claims priority to U.S. Prov. Patent App. No. 63/025,741 filed on May 15, 2020, both of which are incorporated by reference.

### TECHNICAL FIELD

The disclosed embodiments relate to computer networking in general and control plane implementation in SD-WAN in particular.

### BACKGROUND

SD-WANs are policy-driven networks that transport IP packets over multiple different underlay networks to get better WAN bandwidth management, visibility, and control. While some of the underlay networks are private VPNs such as MPLS L2/L3 VPNs, some of the underlay networks are untrusted networks such as the Internet. To secure communication over untrusted underlay networks, IPsec Tunnels are used.

Traditional IPsec tunnels are used without any centralized controller and therefore require stringent authentication and authorization (e.g., via IKE Phase 1) before other properties of IPsec SAs can be exchanged. An IPsec SA between two untrusted nodes typically requires the following configurations and message exchanges: IPsec IKE to authenticate with each other; establish IPsec SA; local key configuration; remote peer address (192.10.0.10↔172.0.01); IKEv2 proposal directly sent to peer; encryption method, integrity sha512; transform set; attached client prefixes discovery; by running routing protocol within each IPsec SA; if multiple IPsec SAs between two peer nodes are established to achieve load sharing, each IPsec tunnel needs to run its own routing protocol to exchange client routes attached to the edges; access list or traffic selector; permit Local-IP1, Remote-IP2.

### SUMMARY

A first aspect relates to a first edge node in an SD-WAN and comprising: a memory configured to store instructions; and a processor coupled to the memory and configured to execute the instructions to cause the first edge node to: establish a secure management tunnel between an R) in the SD-WAN and the first edge node; advertise properties of the first edge node to the RR via the secure management tunnel for the RR to propagate the properties to a second edge node; establish a first secure data channel with the second edge node; and exchange first information with the second edge node.

First, the embodiments provide for controller-facilitated authorization, filtering, and propagation. Second, the embodiments provide for messaging for that authorization, filtering, and propagation. Controller-facilitated authorization, filtering, and propagation simplify the IPsec tunnel establishment process by reducing the messaging among edge nodes and directing at least some of that messaging through a controller. In addition, the embodiments provide for BGP-based segmentation and NAT property messaging.

Optionally, in any of the preceding aspects, the processor is further configured to execute the instructions to cause the first edge node to perform an IKEv2 negotiation with the second edge node.

Optionally, in any of the preceding aspects, the first secure data channel is an IPsec tunnel.

Optionally, in any of the preceding aspects, the processor is further configured to execute the instructions to cause the first edge node to further advertise the properties to the RR via the secure management tunnel for the RR to propagate the properties to a third edge node.

Optionally, in any of the preceding aspects, the processor is further configured to execute the instructions to cause the first edge node to establish a second secure data channel with the third edge node.

Optionally, in any of the preceding aspects, the processor is further configured to execute the instructions to cause the first edge node to exchange second information with the third edge node.

Optionally, in any of the preceding aspects, the processor is further configured to execute the instructions to cause the first edge node to further advertise the properties in a BGP update U1 message, and wherein the BGP update U1 message is configured to advertise an attached client route and comprises an NLRI field, an encapsulation extended community field, and a color extended community field.

Optionally, in any of the preceding aspects, the processor is further configured to execute the instructions to cause the first edge node to further advertise the properties in a BGP update U2 message, and wherein the BGP update U2 message is configured to advertise tunnel attributes and comprises an IPsec sub-TLV.

A second aspect relates to a method implemented by a first edge node in an SD-WAN, the method comprising: establishing a secure management tunnel between an RR in the SD-WAN and the first edge node; advertising properties of the first edge node to the RR via the secure management tunnel for the RR to propagate the properties to a second edge node; establishing a first secure data channel with the second edge node; and exchanging first information with the second edge node.

Optionally, in any of the preceding aspects, the method further comprises performing an IKEv2 negotiation with the second edge node.

Optionally, in any of the preceding aspects, the first secure data channel is an IPsec tunnel.

Optionally, in any of the preceding aspects, the method further comprises further advertising the properties to the RR via the secure management tunnel for the RR to propagate the properties to a third edge node.

Optionally, in any of the preceding aspects, the method further comprises establishing a second secure data channel with the third edge node.

Optionally, in any of the preceding aspects, the method further comprises exchanging second information with the third edge node.

Optionally, in any of the preceding aspects, the method further comprises further advertising the properties in a BGP update U1 message, wherein the BGP update U1 message is configured to advertise an attached client route and comprises an NLRI field, an encapsulation extended community field, and a color extended community field.

Optionally, in any of the preceding aspects, the method further comprises further advertising the properties in a BGP update U2 message, wherein the BGP update U2 message is configured to advertise tunnel attributes and comprises an IPsec sub-TLV.

A third aspect relates to an RR in an SD-WAN and comprising: a receiver configured to: receive first RTC NLRI from a first edge node in the SD-WAN; and receive second RTC NLRI from a second edge node in the SD-WAN; and a processor coupled to the receiver and configured to: install an outbound route filter based on the first RTC NLRI; and process the second RTC NLRI based on the outbound route filter.

Optionally, in any of the preceding aspects, the second RTC NLRI is a BGP update message.

A fourth aspect relates to a method implemented by an RR in an SD-WAN, the method comprising: receiving first RTC NLRI from a first edge node in the SD-WAN; receiving second RTC NLRI from a second edge node in the SD-WAN; installing an outbound route filter based on the first RTC NLRI; and processing the second RTC NLRI based on the outbound route filter.

Optionally, in any of the preceding aspects, the second RTC NLRI is a BGP update message.

Any of the above embodiments may be combined with any of the other above embodiments to create a new embodiment. These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an SD-WAN.

FIG. 2A is a schematic diagram of an extended communities attribute message.

FIG. 2B is the type high field in FIG. 2A.

FIG. 3 is a schematic diagram of an NLRI field.

FIG. 4 is a schematic diagram of an extended sub-TLV.

FIG. 5 is a flowchart illustrating a method of controller-facilitated authorization.

FIG. 6 is a flowchart illustrating a method of controller-facilitated filtering.

FIG. 7 is a schematic diagram of an apparatus according to an embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The following abbreviations apply:

AFI: address family identifier

AS: autonomous system

ASIC: application-specific integrated circuit

BGP: Border Gateway Protocol

CPE: customer-premises equipment

CPU: central processing unit

DSP: digital signal processor

DTLS: Datagram Transport Layer Security

encap: encapsulation

EncapExt: encapsulation extension

EO: electrical-to-optical

ext: extension

FPGA: field-programmable gate array

GRE: Generic Routing Encapsulation

IANA: Internet Assigned Numbers Authority

ID: identifier

IKE: Internet Key Exchange

IKEv2: IKE version 2

IKE_AUTH: IKE authentication

IKE_SA_INIT: IKE SA initial

IP: Internet Protocol

IPsec: Internet Protocol Security

IPv4: Internet Protocol version 4

IPv6: Internet Protocol version 6

ISP: Internet service provider

LAN: local area network

L2: layer 2

L3: layer 3

MPLS: multiprotocol label switching

NAT: network address translation

NLRI: network layer reachability information

OE: optical-to-electrical

PortExt: port extension

RAM: random-access memory

RD: routing domain

RF: radio frequency

RFC: request for comments

ROM: read-only memory

RR: route reflector

rsrv: reserved

RTC: route constraint

RX: receiver unit

SA: security association

SAFI: subsequent address family identifier

SD-WAN: software-defined WAN

SHA512: secure hash algorithm, 512 bits

SRAM: static RAM

STUN: Session Traversal Utilities for NAT

TCAM: ternary content-addressable memory

TLS: Transport Layer Security

TLV: type, length, and value

trans: translation

TX: transmitter unit

VPN: virtual private network

VRF: virtual routing and forwarding

VXLAN: Virtual Extensible LAN

WAN: wide area network.

In a BGP controlled SD-WAN network such as an MPLS-based network adding short-term capacity over the Internet using IPsec, there are secure connections between edge nodes and an RR via a private path, TLS, DTLS, or another technique. The authentication of peer nodes is managed by the RR. When an edge node needs to establish multiple IPsec tunnels to many different edge nodes, all the management information can be multiplexed into the secure management tunnel between the RR and the edge node. Therefore, there is a reduced amount of authentication in a BGP-controlled SD-WAN.

Client VPNs are configured via VRFs just like for existing MPLS VPNs. The IPsec equivalent traffic selectors for local and remote routes are achieved by importing or exporting VPN route targets. The binding of client routes to IPsec SA is dictated by policies. As a result, IPsec configuration for a BGP-controlled SD-WAN (with mixed MPLS VPN) can be simplified as follows:

The SD-WAN controller has the authority to authenticate edges and peers. Remote peer association is controlled by the SD-WAN controller, or RR. Therefore, the IKEv2 proposals can be significantly simplified, especially the authorization and authentication of peer nodes. The IPsec transform set can be sent directly to the peer or incorporated with BGP update messages. BGP update message announce the client route reachability for all permitted parallel tunnels or paths. There is no need to run multiple routing protocols in each IPsec tunnel. Importing or exporting route targets are used under each client VPN (e.g., VRF) to achieve the traffic selection or permission among clients' routes attached to multiple edge nodes.

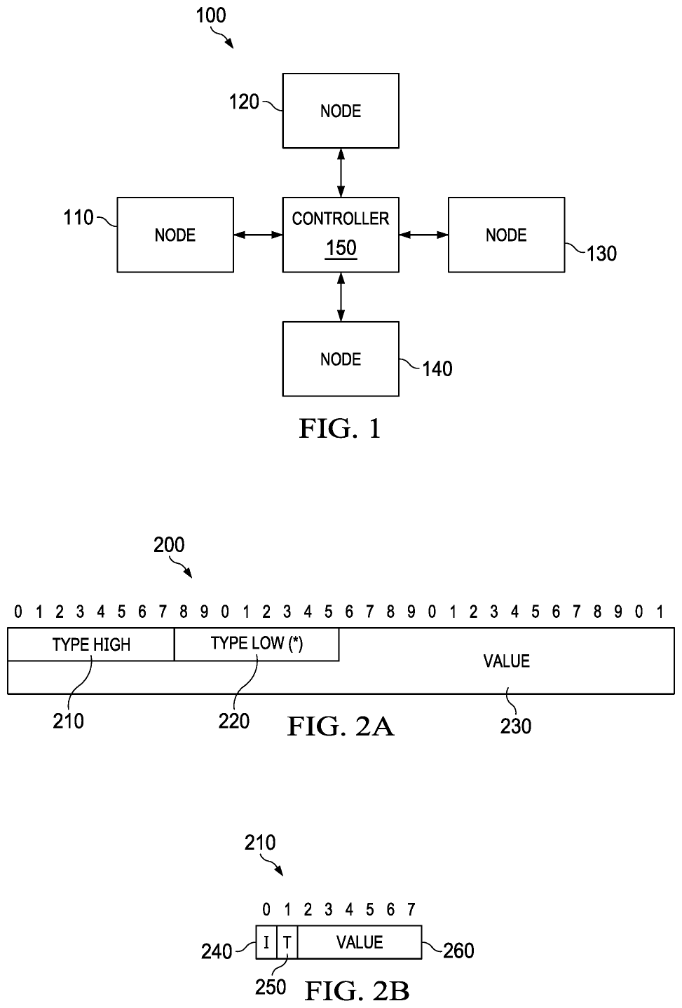

FIG. 1 is a schematic diagram of an SD-WAN 100. The SD-WAN 100 comprises nodes 110, 120, 130, and 140 and a controller 150. The nodes 110, 120, 130, and 140 may be referred to as edge nodes, endpoints, or CPEs when they exist at the edges or ends of the SD-WAN 100. The controller 150 may be referred to as a BGP route controller or an RR. The nodes 110, 120, 130, and 140 and the controller 150 may implement BGP or other protocols. Though four nodes 110, 120, 130, and 140 and one controller 150 are shown, there may be any suitable number of nodes and controllers connected in any suitable form. For instance, each node 110, 120, 130, and 140 may have its own, physically-proximate controller.

In edge discovery, the nodes 110, 120, 130, and 140 discover other nodes 120, 130, and 140 to communicate with. Specifically, the nodes 110, 120, 130, and 140 discover underlay networks, supported SD-WAN instances, routes, and other properties of the other nodes 120, 130, and 140. The nodes 110, 120, 130, and 140 are connected by trusted VPNs, untrusted public networks, or both VPNs and untrusted public networks. When the nodes 110, 120, 130, and 140 are connected by untrusted public networks, they establish IPsec tunnels, TLS tunnels, or other secure channels between each other.

As part of the procedure to establish IPsec tunnels, the nodes 110, 120, 130, and 140 exchange various IKE messages. The IKE messages may be IKEv2 messages, including IKE_SA_INIT messages, IKE_AUTH messages, CREATE_CHILD_SA messages, and informational messages. The IKE_AUTH messages authenticate previous messages, exchange identities and certificates, and establish the first child SA. First, the number of IKE_AUTH messages can grow based on the type of authentication used. Second, one of the nodes 110, 120, 130, and 140 may need to establish an IPsec tunnel with multiple other nodes 110, 120, 130, and 140. Third, two nodes 110, 120, 130, and 140 may need to establish multiple IPsec tunnels between each other in order to handle different client traffic. There is therefore a desire to simplify the IPsec tunnel establishment process.

Disclosed herein are embodiments for control plane implementation in SD-WAN. First, the embodiments provide for controller-facilitated authorization, filtering, and propagation. Second, the embodiments provide for messaging for that authorization, filtering, and propagation. Controller-facilitated authorization, filtering, and propagation simplify the IPsec tunnel establishment process by reducing the messaging among edge nodes and directing at least some of that messaging through a controller. In addition, the embodiments provide for BGP-based segmentation and NAT property messaging.

### Controller-Facilitated Authorization

Instead of the nodes 110, 120, 130, and 140 establishing IPsec tunnels directly with each other, the controller 150 may facilitate that process. Specifically, in SD-WANs implementing BGP, the nodes 110, 120, 130, and 140 already establish secure management tunnels with the controller 150. Thus, the nodes 110, 120, 130, and 140 may exchange IPsec messages, including IKE_AUTH messages, with the controller 150 using BGP update messages in the secure management tunnels. The controller 150 then propagates the BGP update messages to the other nodes 110, 120, 130, and 140.

For example, the node 110 establishes multiple IPsec tunnels with each of the nodes 120, 130, and 140. The node 110 does not exchange separate IPsec messages for each of those IPsec tunnels. Instead, the node 110 sends one set of BGP update messages to the controller 150. The controller 150 then propagates the BGP update messages to the nodes 120, 130, and 140 as necessary. Thus, when the node 110 needs to establish multiple IPsec tunnels with the nodes 120, 130, and 140 the node 110 may multiplex all management information into a secure management tunnel between the node 110 and the controller 150, resulting in a reduced amount of authentication between the nodes 110, 120, 130, and 140. This process of establishing and negotiating via the controller 150 may be referred to as confederated IPsec SA.

### Controller-Facilitated Filtering

BGP has a built-in mechanism to dynamically achieve a constrained distribution of node 110, 120, 130, and 140 information. The built-in mechanism is dynamic because the controller 150 does not have a preconfigured map of node 110, 120, 130, and 140 capabilities. Rather, the nodes 110, 120, 130, and 140 announce their capabilities. Specifically, the nodes 110, 120, 130, and 140 send RTC NLRI to the controller 150 for the controller 150 to install outbound route filters. The nodes 110, 120, 130, and 140 may send the RTC NLRI in BGP update messages.

For example, the node 110 transmits to the controller 150 first RTC NLRI indicating that the node 110 supports instance 1 and instance 2. The instances may be VPNs. The node 120 transmits to the controller 150 second RTC NLRI indicating that the node 120 supports instance 1 and instance 3. The controller 150 stores the first RTC NLRI and the second RTC NLRI. When the node 120 transmits to the controller 150 an advertisement associated with instance 1, the controller 150 forwards the advertisement to the node 110 because the node 110 supports instance 1. The advertisement may be a BGP update message. However, when the node 120 transmits to the controller 150 an advertisement associated with instance 3, the controller 150 does not forward the advertisement to the node 110 because the node 110 does not support instance 3. Similarly, when the node 110 transmits to the controller 150 an advertisement associated with instance 1, the controller 150 forwards the advertisement to the node 120 because the node 120 supports instance 1. However, when the node 110 transmits to the controller 150 an advertisement associated with instance 2, the controller 150 does not forward the advertisement to the node 120 because the node 120 does not support instance 2.

Because SD-WANs span across untrusted public networks, the controller 150 cannot trust RTC NLRI from the nodes 110, 120, 130, and 140. Thus, the controller 150 may implement policies to filter out messages from unauthorized nodes 110, 120, 130, and 140 announcing their interest in instances. Similarly, the policies allow processing of messages only from authorized nodes 110, 120, 130, and 140.

### Controller-Facilitated Propagation

The nodes 110, 120, 130, and 140 may be physically far apart from each other; be connected to each other through untrusted public networks; and not know which of the remaining nodes 110, 120, 130, and 140 are their authorized communication peers. Thus, the nodes 110, 120, 130, and 140 advertise their properties by sending BGP update messages only to the controller 150 through secure tunnels in order to communicate in a quicker and more secure manner. The controller 150 then propagates the BGP update messages to authorized peers and may do so using known constrained route distribution techniques and policies received from the nodes 110, 120, 130, and 140. After receiving the BGP update messages, the authorized peers may compute corresponding private keys, establish secure channels, and exchange additional information.

### Hierarchical Update Messages

The nodes 110, 120, 130, and 140 transmit BGP update messages in a hierarchical manner, meaning in two parts. The two sub-parts are update message U1 and update message U2. Update message U1 is recursively resolved to update message U2, meaning the client route update from update message U1 is resolved based on the information from update message U2. Update message U2 specifies the tunnels terminated at the node 110, 120, 130, and 140 sending update message U1.

Update message U1 advertises an attached client route and comprises an NLRI field, a next-hop address field, an encapsulation extended community field, and a color extended community field. The NLRI field is a prefix, for instance 10.1.1.1, of a client route of the node 110, 120, 130, 140 sending update message U1, for instance the node 110. The next-hop address field is a loop-back address, for instance 2.2.2.2, of the node 110. The encapsulation extended community field indicates that a tunnel type is an SD-WAN hybrid tunnel or another type of tunnel. The color extended community field is red or another color indicating common properties, for instance geographic location, shared by a set of the nodes 110, 120, 130, and 140. Update message U2 identifies those common properties.

Update message U2 advertises detailed tunnel attributes of underlay networks and comprises a tunnel-egress-endpoint sub-TLV, an extended port sub-TLV, a geographic location sub-TLV, and either IPsec sub-TLVs or IPsec SA IDs. The extended port sub-TLV is optional and comprises an ISP property sub-TLV. The IPsec SA IDs are for preconfigured IPsec SAs.

### Update Message U2

Update message U2 may be an IANA-assigned SD-WAN SAFI=74 message, where AFI=1 and SAFI=SD-WAN. In that case, update message U2 may comprise a site type field, a port local ID field, an SD-WAN color field, and an SD-WAN node ID field. The site type field has 1 octet value and defines different types of site IDs to be used in deployment. Site type=1 is for simply deployment such as all edge nodes being under one SD-WAN management system so that a simple identifier is enough for the SD-WAN management to map the site to its precise geolocation. Site type=2 is to indicate that a value in a site ID is locally significant so that a geographic location sub-TLV is used to fully describe an accurate location of the node 110. Site type=2 is for large SD-WAN heterogeneous deployment where site IDs have to be described by proper geographic location of the edge nodes. The port local ID is an SD-WAN edge node port identifier, which can be locally significant. A tunnel path attribute field may include detailed properties about a network connected to a port associated with the NLRI field. When IPsec SAs are preconfigured, the IPsec SA IDs may be included in the tunnel path attribute field. If the NLRI field applies to multiple ports, then the port local ID is null. The SD-WAN color field identifies a common property shared by a set of SD-WAN edge nodes or a group of WAN ports. For instance, the SD-WAN color field identifies a common property of the color identifies in the color extended community field in update message U1. Alternatively, the SD-WAN color field identified a common property of a specific geographic location shared by a group of prefixes.

In addition, update message U2 may comprise a tunnel encapsulation attribute field and a tunnel type field. The tunnel type field may be SD-WAN hybrid to indicate hybrid underlay tunnels. Furthermore, the extended port sub-TLV may be with or without NAT. The IPsec sub-TLVs may be in the tunnel encapsulation attribute field and may include any combination of an IPsec SA nonce sub-TLV, an IPsec SA public key sub-TLV, and an IPsec SA transform sub-TLV.

BGP-Based SD-WAN Segmentation

Instances may also be referred to as segments or slices. Thus, when an SD-WAN is segmented, it implements different instances. It then becomes necessary for BGP messages to differentiate between different instances. For instance, a first instance is associated with payment, a second instance is associated with file transfer, and so on. Each of the nodes 110, 120, 130, and 140 may need to support multiple instances. Traffic of one of the nodes 110, 120, 130, and 140 may need to be mapped to different instances based on a node policy. For instance, traffic of the first instance must propagate to a gateway and traffic of the second instance must propagate to all of the nodes 110, 120, 130, and 140. Thus, there is a need to encode the instances in a way that is different from encoding MPLS VPNs.

To encode the instances, the color extended community field in update message U1 comprises an SD-WAN target ID that identifies an instance. The SD-WAN target ID may be the same as the route target for IP VPN so that edge nodes can keep the client route advertisements the same as in MPLS VPNs. The MPLS VPN SAFI=128 message and its route distinguisher field can be used for routes belonging to different SD-WAN instances.

### SD-WAN Target ID

FIG. 2A is a schematic diagram of an extended communities attribute message 200. The extended communities attribute message 200 is another alternative for messaging the SD-WAN target ID. The extended communities attribute message 200 is described in S. Sangli, et al., “BGP Extended Communities Attribute,” RFC 4360, February 2006. The extended communities attribute message 200 comprises a type high field 210, a type low field 220, and a value field 230. The type high field and the type low field have a combined size of 1 octet in regular messages and 2 octets in extended messages. The type high field 210 indicates whether an extended community is a regular type or an extended type and is described further below. The type low field 220 may be present for extended messages only and comprised in the value field 230. The value field 230 is either 6 octets when the combined size of the type high field 210 and the type low field 220 is 2 octets or 7 octets when the combined size of the type high field 210 and the type low field 220 is 1 octet. The value field 230 depends on the type of community specified in the type high field 210 and the type low field 220.

FIG. 2B is the type high field 210 in FIG. 2A. The type high field 210 comprises an I field 240, a T field 250, and a value field 260. The I field 240 comprises an IANA authority bit. A value of 0 indicates an IANA-assignable type using a “first come first serve” policy. A value of 1 indicates that part of the type high field 210 and the type low field 220 is for IANA-assignable types using either the standard action or the early IANA allocation policy and indicates that the rest of the type high field 210 and the type low field 220 is for experimental use. The T field 250 comprises a transitive bit. A value of 0 indicates “transitive” when a node 110, 120, 130, and 140 at an edge sends a message to the controller 150 and the controller is in a different AS. A value of 1 indicates “non-transitive” when the controller 150 sends the message to the node 110, 120, 130, and 140 at the edge. The value field 260 is 6 bits and may comprise the SD-WAN target ID. Alternatively, the type low field 220 comprises the SD-WAN target ID.

### Binding Traffic With SD-WAN Instances

The nodes 110, 120, 130, and 140 may need to map traffic to different SD-WAN instances. When the nodes 110, 120, 130, and 140 send BGP messages indicating their routes, the BGP messages comprise an identifier indicating which routes belong to which instances. The AS number may not suffice as the identifier because multiple instances may share the same AS number. In addition, since SD-WAN is an overlay network, it may not be appropriate to use MPLS labels to differentiate instances.

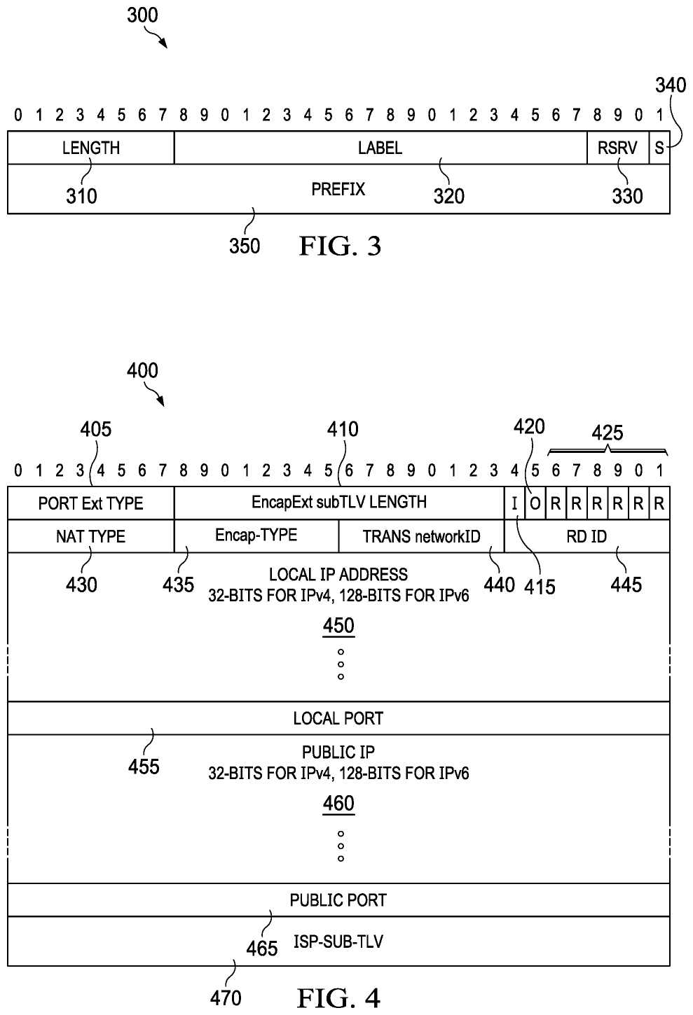

FIG. 3 is a schematic diagram of a NLRI field 300. The NLRI field 300 may be the NLRI field in update message U1 described above and may comprise instance IDs. The NLRI field 300 is described in E. Rosen, “Using BGP to Bind MPLS Labels to Address Prefixes,” RFC 8277, October 2017. The NLRI field 300 comprises a length field 310, a label field 320, an rsrv field 330, an S field 340, and a prefix field 350. The length field 310 is 1 octet and indicates a length in bits of the remainder of the NLRI field 300. The label field 320 is 20 bits and comprises an SD-WAN instance ID. The rsrv field 330 is 3 bits and should be set to 0 on transmission and must be ignored on reception. The S field 340 is 1 bit and must be set to one on transmission and must be ignored on reception. The prefix field 350 is 32 bits or less, 128 bits or less, or 192 bits or less and comprises a prefix bound to an SD-WAN instance identified by the SD-WAN instance ID in the label field 320.

### NAT Property Messaging

When one of the nodes 110, 120, 130, and 140 is connected to an underlay network via a port behind NAT devices, the node 110, 120, 130, and 140 can use IPsec IKE for NAT negotiation. When the node 110, 120, 130, and 140 connects to multiple peers through the underlay network, the pair-wise nature of IPsec IKE for NAT negotiation is inefficient. Thus, the node 110, 120, 130, and 140 may transmit NAT properties of a WAN port to the controller 150 in an extended sub-TLV of a BGP update message. The extended sub-TLV describes the NAT properties when the WAN port is behind a NAT device.

FIG. 4 is a schematic diagram of an extended sub-TLV 400. The extended sub-TLV 400 is described in L. Dunbar, et al., “BGP UPDATE for SDWAN Edge Discovery,” draft-dunbar-idr-sdwan-edge-discovery-01, Nov. 18, 2020. The extended sub-TLV 400 comprises a port ext type field 405, an EncapExt subTLV length field or PortExt subTLV length field 410, an I field 415, an O field 420, 6 R fields 425, a NAT type field 430, an encap type field 435, a trans network ID field 440, an RD ID field 445, a local IP address field 450, a local port field 455, a public IP field 460, a public port field 465, and an ISP sub-TLV field 470.

The port ext type field 405 is 1 octet and indicates the extended sub-TLV 400 is a port extension sub-TLV. The EncapExt subTLV length field is 2 octets and indicates a length of the extended sub-TLV 400. The I field 415 is 1 bit and indicates a CPE port address or inner address scheme; a value of 0 indicates an inner (private) address is IPv4, and a value of 1 indicates the inner address is IPv6. The 0 field 420 is 1 bit and indicates an outer address scheme; a value of 0 indicates a public (outer) address is IPv4, and a value of 1 indicates the public address is IPv6. The R field 425 are each 1 bit and are reserved for future use.

The NAT type field 430 is 1 octet and indicates whether a NAT type is without NAT, 1:1 static NAT, full cone, restricted cone, port-restricted cone, symmetric, or unknown with no response from a STUN server. A node 110, 120, 130, and 140 gets NAT properties from a STUN server via requests and responses, and peers of the node 110, 120, 130, and 140 may not be able to access the STUN server. The encap type field 435 is 1 octet and indicates supported encapsulation types for a port facing a public network such as IPsec+GRE, IPsec+VXLAN, IPsec without GRE, or GRE when packets do not need encryption. The trans network ID field 440 is 1 octet and indicates a globally-unique ID assigned to a transport network by a central controller. The RD ID field 445 is 1 octet and indicates an RD ID that needs to be globally unique.

The local IP address field 450 is either 32 bits for IPv4 or 128 bits for IPv6 and indicates a local (private) IP address of a port. The local port field 455 is 3 octets and is used by a remote SD-WAN edge node for establishing IPsec to the port. The public IP field 460 is either 32 bits for IPv4 or 128 bits for IPv6 and is either an IP address after NAT or set to null when NAT is not used. The public port field 465 is 3 octets and is either an IP address after NAT or set to null when NAT is not used. The ISP sub-TLV field 470 is 6 octets and.

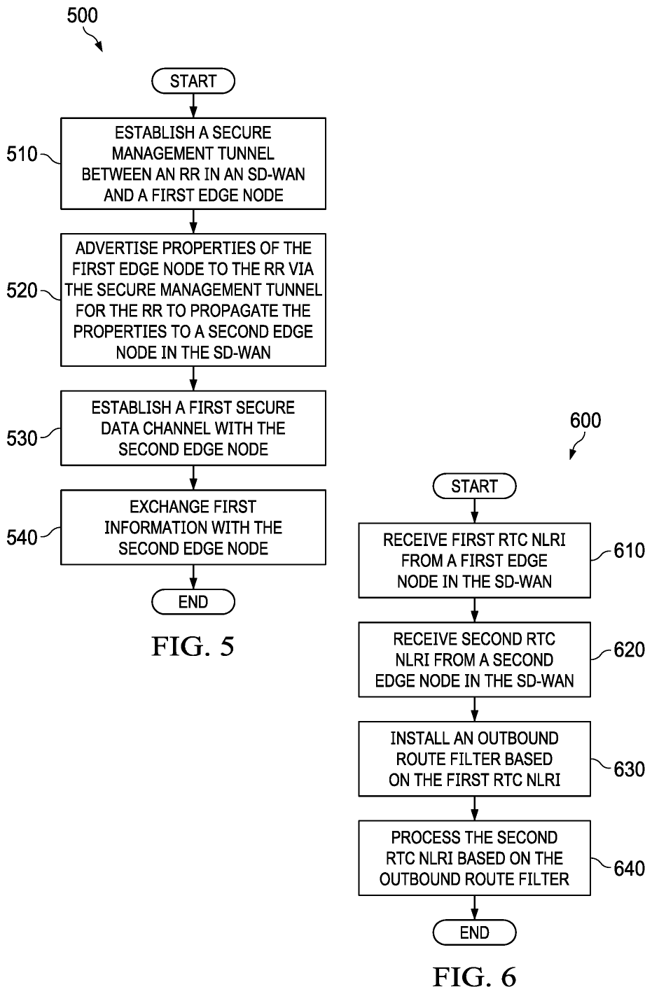

FIG. 5 is a flowchart illustrating a method 500 of controller-facilitated authorization. The node 110 may implement the method 500. At step 510, a secure management tunnel is established between an RR in an SD-WAN and a first edge node. For instance, the RR is the controller 150, the SD-WAN is the SD-WAN 100, and the first edge node is the node 110. At step 520, properties of the first edge node are advertised to the RR via the secure management tunnel for the RR to propagate the properties to a second edge node. For instance, the second edge node is the node 120. At step 530, a first secure data channel is established with the second edge node. At step 540, first information is exchanged with the second edge node

The method 500 may implement additional embodiments as follows: The method further comprises performing an IKEv2 negotiation with the second edge node. The first secure data channel is an IPsec tunnel. The method further comprises further advertising the properties to the RR via the secure management tunnel for the RR to propagate the properties to a third edge node. The method further comprises establishing a second secure data channel with the third edge node. The method further comprises exchanging second information with the third edge node. The method further comprises further advertising the properties in a BGP update U1 message, wherein the BGP update U1 message is configured to advertise an attached client route and comprises an NLRI field, an encapsulation extended community field, and a color extended community field. The method further comprises advertising the properties in a BGP update U2 message, wherein the BGP update U2 message is configured to advertise tunnel attributes and comprises an IPsec sub-TLV.

FIG. 6 is a flowchart illustrating a method 600 of controller-facilitated filtering. The controller 150 may implement the method 600. At step 610, first RTC NLRI is received from a first edge node in the SD-WAN. For instance, the first edge node is the node 110 and the SD-WAN is the SD-WAN 100. At step 620, second RTC NLRI is received from a second edge node in the SD-WAN. For instance, the second edge node is the node 120. At step 630, an outbound route filter based on the first RTC NLRI is installed. At step 640, the second RTC NLRI is processed based on the outbound route filter.

The method 600 may implement additional embodiments as follows: The second RTC NLRI is a BGP update message.

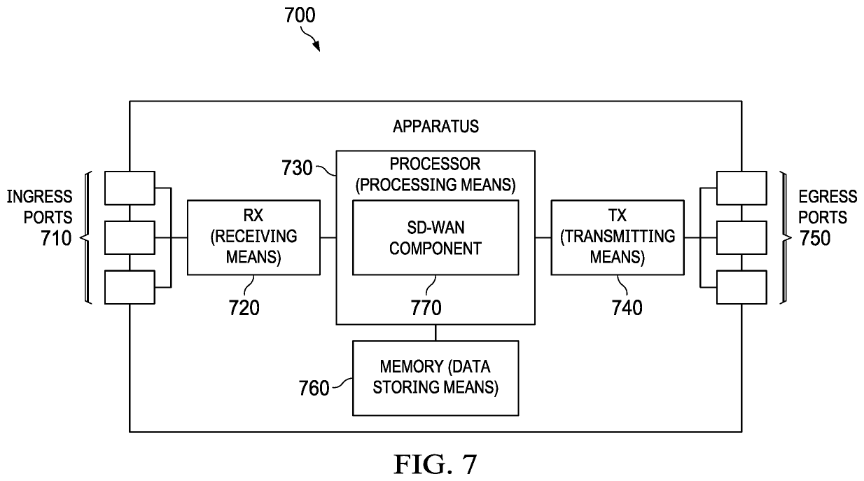

FIG. 7 is a schematic diagram of an apparatus 700 according to an embodiment of the disclosure. The apparatus 700 may implement the disclosed embodiments. The apparatus 700 comprises ingress ports 710 and an RX 720 or receiving means to receive data; a processor, 730 or processing means, or logic unit, baseband unit, or CPU, to process the data; a TX 740 or transmitting means and egress ports 750 to transmit the data; and a memory 760 or data storing means to store the data. The apparatus 700 may also comprise OE components, EO components, or RF components coupled to the ingress ports 710, the RX 720, the TX 740, and the egress ports 750 to provide ingress or egress of optical signals, electrical signals, or RF signals.

The processor 730 is any combination of hardware, middleware, firmware, or software. The processor 730 comprises any combination of one or more CPU chips, cores, FPGAs, ASICs, or DSPs. The processor 730 communicates with the ingress ports 710, the RX 720, the TX 740, the egress ports 750, and the memory 760. The processor 730 comprises an SD-WAN component 770, which implements the disclosed embodiments. The inclusion of the SD-WAN component 770 therefore provides a substantial improvement to the functionality of the apparatus 700 and effects a transformation of the apparatus 700 to a different state. Alternatively, the memory 760 stores the SD-WAN component 770 as instructions, and the processor 730 executes those instructions.

The memory 760 comprises any combination of disks, tape drives, or solid-state drives. The apparatus 700 may use the memory 760 as an over-flow data storage device to store programs when the apparatus 700 selects those programs for execution and to store instructions and data that the apparatus 700 reads during execution of those programs. The memory 760 may be volatile or non-volatile and may be any combination of ROM, RAM, TCAM, or SRAM.

A computer program product may comprise computer-executable instructions for storage on a non-transitory medium and that, when executed by a processor, cause an apparatus to perform any of the embodiments. The non-transitory medium may be the memory 760, the processor may be the processor 730, and the apparatus may be the apparatus 700.

In an embodiment a first edge node in an SD-WAN comprises a memory storing means and a processing means. The memory storing means is configured to store instructions. The processing means is configured to execute the instructions to cause the first edge node to: establish a secure management tunnel between an RR in the SD-WAN and the first edge node; advertise properties of the first edge node to the RR via the secure management tunnel for the RR to propagate the properties to a second edge node; establish a first secure data channel with the second edge node; and exchange first information with the second edge node.

An embodiment includes a first edge node in an SD-WAN. The first edge node comprises a processor and a transmitter. The processor is configured to establish a secure management tunnel between the first edge node and an RR in the SD-WAN; and generate a message comprising properties of an underlay network, wherein the message is for announcing attached clients, and wherein the message is sent to the RR to propagate to a second edge node that is authorized to receive the message based on policies on RR. The transmitter is coupled to the processor and configured to transmit the message to the RR through the secure management tunnel.

Additional embodiments are as follows: The second edge node being authorized by the RR eliminates the steps for the first edge node to authenticate the second edge node that are required by IKEv2 negotiation steps. The message is configured to pass required IPsec attributes or identifiers of previously-established IPsec SAs needed to establish a first IPsec tunnel with the second edge node. The message is configured to be authenticated to be propagated to a third edge node in the SD-WAN. The message is further configured to be authenticated by the RR to propagate the message to the third edge node. The message is further configured to establish a second IPsec tunnel with the third edge node. The message is a BGP update U1 message configured to advertise an attached client route and comprising an NLRI field, an encapsulation extended community field, and a color extended community field that associates with a separate BGP update message that advertises properties of underlay networks. The message is a BGP update U2 message configured to advertise underlay tunnel attributes and comprising an IPsec sub-TLV.

An RR is in an SD-WAN. The RR comprises a receiving element and a processing element. The receiving element is configured to: receive RTC NLRI from a first edge node in the SD-WAN; and receive an advertisement from a second edge node in the SD-WAN. The processing element is configured to: install an outbound route filter based on the RTC NLRI; and make, based on the route filter, a determination whether to propagate the advertisement to the first edge node.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A first edge node in a software-defined wide area network (SD-WAN) and comprising:
a memory configured to store instructions; and
a processor coupled to the memory and configured to execute the instructions to cause the first edge node to:
establish a secure management tunnel between a route reflector (RR) in the SD-WAN and the first edge node;
advertise properties of the first edge node to the RR via the secure management tunnel for the RR to propagate the properties to a second edge node in the SD-WAN;
establish a first secure data channel with the second edge node; and
exchange first information with the second edge node.

2. The first edge node of claim 1, wherein the processor is further configured to execute the instructions to cause the first edge node to perform an Internet Key Exchange version 2 (IKEv2) negotiation with the second edge node.

3. The first edge node of claim 1, wherein the first secure data channel is an Internet Protocol Security (IPsec) tunnel.

4. The first edge node of claim 3, wherein the processor is further configured to execute the instructions to cause the first edge node to further advertise the properties to the RR via the secure management tunnel for the RR to propagate the properties to a third edge node.

5. The first edge node of claim 4, wherein the processor is further configured to execute the instructions to cause the first edge node to establish a second secure data channel with the third edge node.

6. The first edge node of claim 5, wherein the processor is further configured to execute the instructions to cause the first edge node to exchange second information with the third edge node.

7. The first edge node of claim 1, wherein the processor is further configured to execute the instructions to cause the first edge node to further advertise the properties in a Border Gateway Protocol (BGP) update U1 message, and wherein the BGP update U1 message is configured to advertise an attached client route and comprises a network layer reachability information (NLRI) field, an encapsulation extended community field, and a color extended community field.

8. The first edge node of claim 1, wherein the processor is further configured to execute the instructions to cause the first edge node to further advertise the properties in a Border Gateway Protocol (BGP) update U2 message, and wherein the BGP update U2 message is configured to advertise tunnel attributes and comprises an Internet Protocol Security (IPsec) sub-type, length, and value (sub-TLV).

9. A method implemented by a first edge node in a software-defined wide area network (SD-WAN), the method comprising:
establishing a secure management tunnel between a route reflector (RR) in the SD-WAN and the first edge node;
advertising properties of the first edge node to the RR via the secure management tunnel for the RR to propagate the properties to a second edge node in the SD-WAN;
establishing a first secure data channel with the second edge node; and
exchanging first information with the second edge node.

10. The method of claim 9, further comprising performing an Internet Key Exchange version 2 (IKEv2) negotiation with the second edge node.

11. The method of claim 9, wherein the first secure data channel is an Internet Protocol Security (IPsec) tunnel.

12. The method of claim 11, further comprising further advertising the properties to the RR via the secure management tunnel for the RR to propagate the properties to a third edge node.

13. The method of claim 12, further comprising establishing a second secure data channel with the third edge node.

14. The method of claim 13, further comprising exchanging second information with the third edge node.

15. The method of claim 9, further comprising further advertising the properties in a Border Gateway Protocol (BGP) update U1 message, wherein the BGP update U1 message is configured to advertise an attached client route and comprises a network layer reachability information (NLRI) field, an encapsulation extended community field, and a color extended community field.

16. The method of claim 9, further comprising further advertising the properties in a Border Gateway Protocol (BGP) update U2 message, wherein the BGP update U2 message is configured to advertise tunnel attributes and comprises an Internet Protocol Security (IPsec) sub-type, length, and value (sub-TLV).

17. A route reflector (RR) in a software-defined wide area network (SD-WAN) and comprising:
a receiver configured to:
receive first route constraint (RTC) network layer reachability information (NLRI) from a first edge node in the SD-WAN; and
receive second RTC NLRI from a second edge node in the SD-WAN; and
a processor coupled to the receiver and configured to:
install an outbound route filter based on the first RTC NLRI; and
process the second RTC NLRI based on the outbound route filter.

18. The RR of claim 17, wherein the second RTC NLRI is a Border Gateway Protocol (BGP) update message.

19. A method implemented by a route reflector (RR) in a software-defined wide area network (SD-WAN), the method comprising:
receiving first route constraint (RTC) network layer reachability information (NLRI) from a first edge node in the SD-WAN;
receiving second RTC NLRI from a second edge node in the SD-WAN;
installing an outbound route filter based on the first RTC NLRI; and
processing the second RTC NLRI based on the outbound route filter.

20. The method of claim 19, wherein the second RTC NLRI is a Border Gateway Protocol (BGP) update message.
